(19) United States
(12) Patent Application Publication
(10) Pub. No.: US 2011/0120110 A1
(43) Pub. Date: May 26, 2011

(54) Logic controlled de-coupled displacement-type stirling engine

(76) Inventor: John Lee Warren, Aldergrove (CA)

(21) Appl. No.: 12/923,962

(22) Filed: Oct. 18, 2010

Related U.S. Application Data
(60) Provisional application No. 61/279,088, filed on Oct. 16, 2009.

(51) Int. Cl. F02G 1/043

(52) U.S. Cl. 60/520

(57) ABSTRACT

A low temperature differential Stirling engine includes a sealed elongate hollow container having a corresponding elongate cavity therein containing a gaseous working fluid and a displacer slidably mounted in the cavity. The displacer is translatable along the cavity. The container has a hot end and an opposite cold end. Translation of the displacer along the cavity forces the working fluid into the hot or cold ends sequentially according to a Stirling cycle. The hot end of the container has a power piston conduit. The conduit is in fluid communication with a power piston cylinder containing a power piston slidably mounted therein. Thus the conduit is in fluid communication between the working fluid in the cavity in the hot end of the container and the power piston cylinder so that heated expansion of the working fluid in the hot end of the container produces a power stroke of the piston. The displacer is mechanically decoupled from said power piston.

### CROSS REFERENCE TO RELATED APPLICATION

This application claims priority from U.S. Provisional Patent Application Ser. No. 61/279,088 filed Oct. 16, 2009 and entitled Logic Controlled Stirling Engine.

### FIELD OF THE INVENTION

This invention relates to the field of heat engines and in particular to a de-coupled displacement type Stirling engine wherein the displacer is not mechanically coupled to the power piston.

### BACKGROUND OF THE INVENTION

The sterling engine is a class of heat engines considered as a closed cycle system. The working gas is permanently contained within the system.

Displacement type Stirling engines, use an insulated mechanical displacer to push the working gas between the hot and cold sides of the cylinder. The displacer is large enough to insulate the hot and cold sides of the cylinder thermally. A large quantity of gas is displaced. There is a large enough of a gap between the displacer and the cylinder wall to allow gas to flow around the displacer easily.

These engines can operate at low temperature differentials because of the large volume of gas that is can expand to can push on the piston.

Typical low temperature differential Stirling engines may utilize a crank shaft attached to a flywheel. Typically, a single power piston is arranged within the same cylinder on the same shaft as a displacer piston. The displacer piston is a loose fit and does not extract any power from the expanding gas but only serves to shuttle the working gas from the hot heat exchanger to the cold heat exchanger. When the working gas is pushed to the hot end of the cylinder it expands and pushes the power piston. When it is pushed to the cold end of the cylinder it contracts and the momentum of the machine, enhanced by the flywheel, pushes the power piston the other way to compress the gas. The mechanism, in such a Sterling engine, can only move the displacer a short distance. This type of Sterling engine may not be effective at utilizing natural heat sources.

These prior art Sterling engines do not ensure the working gas has fully heated and cooled. Full heating and full cooling is defeated by the direct mechanical coupling of the power piston to the displacer piston. This limits the amount of work that can be performed.

### SUMMARY OF THE INVENTION

In summary, the low temperature differential Stirling engine according to one aspect of the present invention may be characterized as including a sealed elongate hollow container such as a cylinder, having a corresponding elongate cavity therein containing a gaseous working fluid and a displacer slidably mounted in the cavity. The displacer is translatable along the cavity. The container has a hot end and an opposite cold end. Translation of the displacer along the cavity forces the working fluid into the hot or cold ends sequentially according to a Stirling cycle. The hot end of the container has a power piston conduit. The conduit is in fluid communication with a power piston cylinder containing a power piston slidably mounted therein. Thus the conduit is in fluid communication between the working fluid in the cavity in the hot end of the container and the power piston cylinder so that heated expansion of the working fluid in the hot end of the container produces a power stroke of the piston. The displacer is mechanically decoupled from said power piston.

An actuator is mounted substantially within the container. A corresponding processor provides logic control of the actuator. The actuator translates the displacer between the hot and cold ends according to, and so as to optimize, the Stirling cycle operating in the container.

Advantageously a power take-off is connected to the piston so as to produce useful work from the piston at least during the piston's power stroke. The power take-off may provide power to the actuator.

In one embodiment the actuator includes a motor operating to translate the displacer according to logic controls from the processor. The processor is advantageously adapted to maintain the position of the displacer in the hot end or in the cold end of the container until the working fluid is fully heated or cooled. A generator may provide power for driving the motor. The generator may be included as part of the power take-off so that the generator is driven by some of the power from the piston's power stroke. Thus the power take-off further includes a transmission producing useful work, including the generator.

In one embodiment the actuator includes a counter-balance weight counter-balancing the displacer to thereby reduce power requirements of the motor. In this embodiment the actuator further includes an elongate flexible member such as a cord, line, cable, etc suspending, on opposite ends thereof, the displacer and the counter-balance weight. The motor engages and drives the flexible member so as to vertically translate the counter-balanced displacer and weight.

In a further embodiment the actuator includes a screw which is driven by the motor. The screw helically engages the displacer with its helical threads to translate the displacer vertically.

Advantageously, the screw may be off-set from the centroidal axis of the displacer so as to inhibit rotation about a vertical axis of the displacer relative to the container when the container's cavity and the displacer are both cylindrical. Other means may be employed to inhibit such rotation of the displacer.

The processor may obtain displacer location information from micro switches, contacting the displacer, located on top or bottom of the cavity.

In another embodiment, the motor used to move the displacer may be a logic controlled stepper motor that has the angle of rotation controlled so that the displacer is location is controlled precisely.

In one embodiment the processor is adapted to maintain the position of the displacer according to active feedback to the processor of the thermodynamic status of the working fluid. Alternatively the processor may be adapted to maintain the position of the displacer according to a time value.

### BRIEF DESCRIPTION OF THE DRAWINGS

FIG. 1 is, a partially cut away, perspective view, a cylinder containing a displacer, wherein the cylinder and its corresponding power piston cylinder is sectioned in half along a sectional plane intersecting the longitudinal axis of symmetry of the cylinder.

FIG. 1a is an enlarged view of a portion of FIG. 1.

FIG. 2 is, a partially cut away view, the upper end of the power piston cylinder and piston, and the power take-off from the power piston.

FIG. 3 is, a partially cut away perspective view, a further embodiment of the invention wherein the cylinder is sectioned as in FIG. 1, and wherein the displacer is also longitudinally sectioned substantially in half.

FIG. 4 is an alternative embodiment of the engine of FIG. 3 wherein the cylinder and cylinder head supporting the displacer motor is cut away to expose the displacer within the cylinder.

FIG. 5 is the embodiment of FIG. 4 in right side view and showing a one way valve mounted in the piston conduit.

FIG. 6 is the motor and top plate of FIG. 5 in exploded view.

### DETAILED DESCRIPTION OF EMBODIMENTS OF THE INVENTION

In the accompanying illustrations, like reference numerals denote corresponding parts in each view.

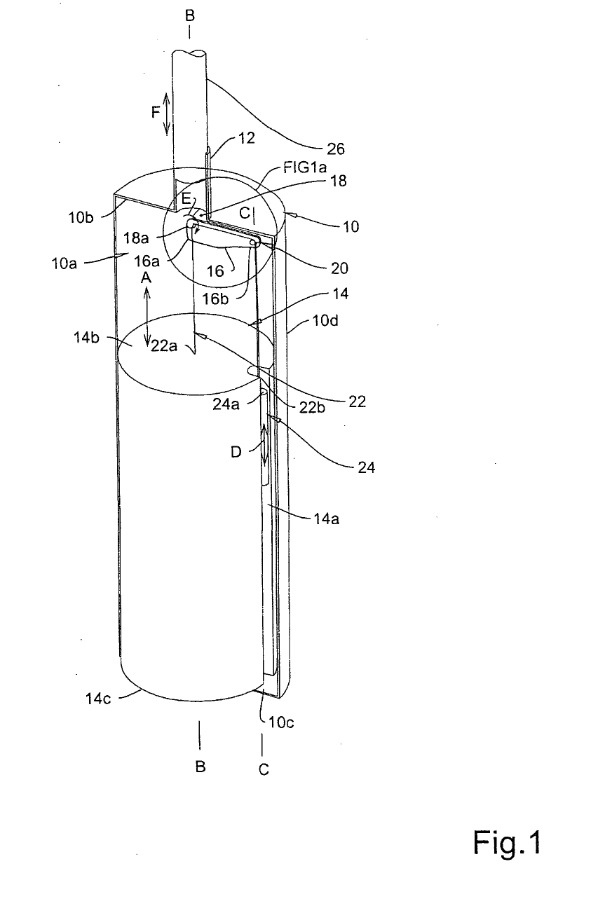

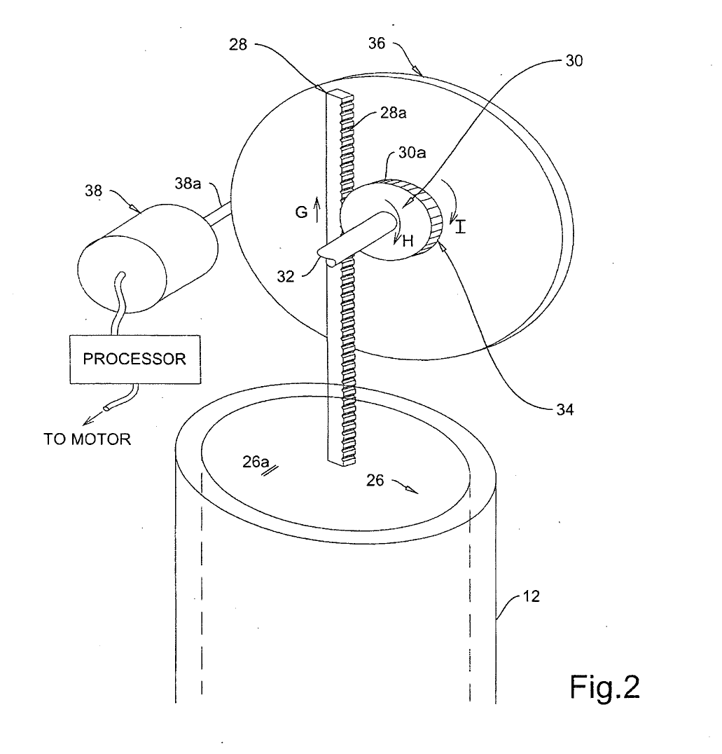

As seen in FIG. 1, a container such as cylinder 10, is provided. Cylinder 10 is a closed-ended cylindrical container having only an opening communicating into the adjoining power piston cylinder 12. Cylinder 10 contains, in a relatively loose fit therein, a solid displacer piston or displacer 14. Displacer 14 is free to translate in direction A longitudinally along, so as to be coaxially aligned along, longitudinal axis B of cylinder 10. Cylinder 10, and its corresponding internal cavity 10a, have a longer longitudinal dimension than the longitudinal dimension of displacer 14 so that, no matter where displacer 14 is positioned in its translation with in cavity 10a, a constant volume free space is defined collectively between end 10b of cylinder 10 and corresponding end 14b of displacer 14 and between end 10c of cylinder 10 and corresponding end 14c of displacer 14. In one embodiment, channel 14a is formed in side wall of displacer 14 and extends substantially the entire length of displacer 14.

A pulley bracket 16 is mounted to the cylinder head on end 10b of cylinder 10. Bracket 16 is mounted so as to position a concentrically inner most of end 16c of bracket 16 so as to lie substantially on axis B. The opposite end 16b of bracket 16, that is, the distal end, is aligned radially outwardly and/or orthogonally to axis B, flush along end 10b and adjacent cylindrical cylinder wall 10d. The distal end of bracket 16 is aligned longitudinally with the longitudinal axis C of channel 14a.

An electric motor 18 having a corresponding driven shaft 18a is mounted on one side of the radially on the inner end 16a of bracket 16 so as to extend driven shaft 18a through a corresponding aperture in end 16a and so as to dispose the driven shaft 18a through the aperture to protrude from bracket 16 opposite to motor 18. A pulley 20 is mounted on the distal end 16b of bracket 16 so as to protrude from bracket 16 on the same side of bracket 16 as driven shaft 18a. A cord 22 or other substantially non-resilient elongate flexible member such as for example a line or cable is mounted at its end 22a to end 14b of displacer 14 so as to place end 22a of cord 22 substantially on longitudinal axis B. The protruding end of driven shaft 18a also lies on longitudinal axis B, and thus, with cord 22, between end 22a and driven shaft 18a, is substantially coaxial with longitudinal axis B. Cord 22 extends from where it is wrapped over driven shaft 18a to pulley 20. Cord 22 wraps over pulley 20 and extends then substantially along longitudinal axis C to where the opposite end of cord 22, namely end 22b, is mounted to counter weight 24, and in particular to end 24a of counter weight 24. Counter weight 24 is journalled in channel 14a and free to translate along channel 14a in direction D in counter balancing oppositely disposed translation relative to displacer 14 as displacer 14 translates in direction A. Counter weight 24 may be substantially equal in weight to displacer 14 so that, with counter weight 24 tethered to displacer 14 by cord 22, translating cord 22 over driven shaft 18a and pulley 20 may be done with relatively little torque applied by motor 18 to rotate driven shaft 18a in direction E. Cylinder 10 is oriented vertically, that is, so that longitudinal axis B is vertical. Displacer 14 may thus be elevated so as to bring end 14b towards end 10b as counter weight 24 is correspondingly lowered along channel 14a.

Power piston 26 is freely mounted within power piston cylinder 12 so as to freely translate in direction F to accomplish work when driven upwardly by the pressure of the working fluid, for example, air, contained within the hot end of cylinder 10, that is, upper cavity 10a between displacer 14 and end 10b of cylinder 10.

In one example, which is not intended to be limiting, of removing work from the upward power stroke of power piston 26 in power piston cylinder 12, a rack gear 28 may be mounted to the upper end 26a of piston 26 and extend vertically therefrom so as to engage linearly aligned gear teeth 28a with the corresponding teeth 30a on one-way ratchet gear 30. One-way ratchet gear 30 is mounted on a shaft 32 by means of a one-way ratchet mechanism 34, itself mounted onto shaft 32. A large gear or flywheel 36 is also mounted onto shaft 32. As rack gear 28 is driven upwardly in direction G, gear 30 is rotated in direction H, thereby, by the one-way drive of ratchet 34, also rotating flywheel 36 in direction I on shaft 32.

When the pressure under power piston 26, that is, within the upper cavity 10a within cylinder 10, is reduced by the operation of the sterling cycle, and power piston 26 retracts downwardly along power piston cylinder 12, rack gear 28 is lowered and, by the operation of one-way ratchet 34, gear 30 free-wheels in a direction in opposite to direction H without interfering with the rotation of gear 36 in direction I. Rotation of gear 36 in direction I drives a generator shaft 38a which causes the corresponding generator 38 to generate electricity to power motor 18 as governed by a processor 19. Processor 19 is a logic controller for the operation of motor 18.

The above described arrangement produces a positive net work which may be extracted from the rotation of gear 36.

Although not intending to be limiting, the cold or heat sink end 10c of cylinder 10 may be mounted in a geo-thermal arrangement so as to produce a temperature differential between the heat sink end, and the ambient temperature or hot end which may be the upper end 10b of cylinder 10.

One such geo-thermal arrangement could be a cylinder mounted in a hole where, in winter, the hot end is placed well below the frost line. The cold end sticks out of the hole. In this arrangement, the cold side would become the hot side and the hot side would become the cold side in summer.

As will be understood by those skilled in the art, the illustration of FIG. 1 is intended to merely be representative and not meant to be limiting. As those skilled in the art will appreciate, given this disclosure, cylinder 48 may be advantageously quite long, although illustrated as a relatively short container; the de-coupling of displacer 14 from power piston 26 thereby allowing greater translation distances along axis B for displacer 14 as not being constrained by the position of power piston 26 due to the lack of any physical mechanical linkage there between. Displacer 46 may be of quite light or low density material such as styro-foam or wood. Further it will be appreciated that the selective positioning of displacer 14 in this embodiment, by the operation of its actuator as governed by the hoisting and lowering of displacer 14 by the operation of the motor 18 and driven shaft 18a operating on cord 22, will allow processor controlled positioning which will accomplish more efficient full heating of the working fluid and full cooling of the working fluid when the working fluid is either in the hot end or the cold end respectively of cylinder 10.

For the operation of the Stirling cycle, end 10b of cylinder 10 is thus placed into heat while the other end 10c is placed in cold. In one embodiment, 10b end of the cylinder could be placed in a hole in the ground to take advantage of a geo-thermal difference in temperature between for example ambient air temperature above ground and the temperature in the hole for example where one end of the cylinder could be below the frost line.

The steps of operation are as follows;
1) When the displacer is at the top of the cylinder, the gas is heated by the environment.
2) Based on either active feedback, or by a time value, the logic controller in the processor causes the motor to winch the displacer to the bottom of the cylinder. The effort to move the displacer is reduced by the counter weight that weighs the same as the displacer. As the displacer moves down to the bottom, the gas working fluid is forced to move past the displacer and up to the top of the cylinder.
3) The gas is then cooled by the environment.
4) Based on either active feedback, or by a time value, a logic controller causes the motor to winch the displacer to the top of the cylinder. The effort to move the displacer is reduced by the counter weight the weighs the same as the displacer. As the displacer moves up to the top, gas is forced to move down to the bottom of the cylinder.

During this operation the power piston is used to power a generator. A small portion of the generated electricity is used to power the motor and logic controller.

Having the logic controller wait until the gas is fully heated and cooled, increases the work produced during the cycle. Cycles that rely on a flywheel or spring mechanically linked to the piston and/or displacer to control the cycle of time of operation, do not necessarily allow enough time for the working gas to cool or heat.

As stated above, typically low temperature differential Stirling engines have a small displacer movement. In order for the device to be placed in a thermal well for geothermal electricity generation, the displacer movement must be much larger. This is accomplished with the present design.

It can be seen by someone skilled in the art that the displacer may be actuated by a motor and logic controller and also by other means than the one presented here. Therefore this invention is not intended to be limited to this mechanical configuration.

The Sterling engine may be pressurized so that larger loads may be moved by the heating or cooling of the gas.

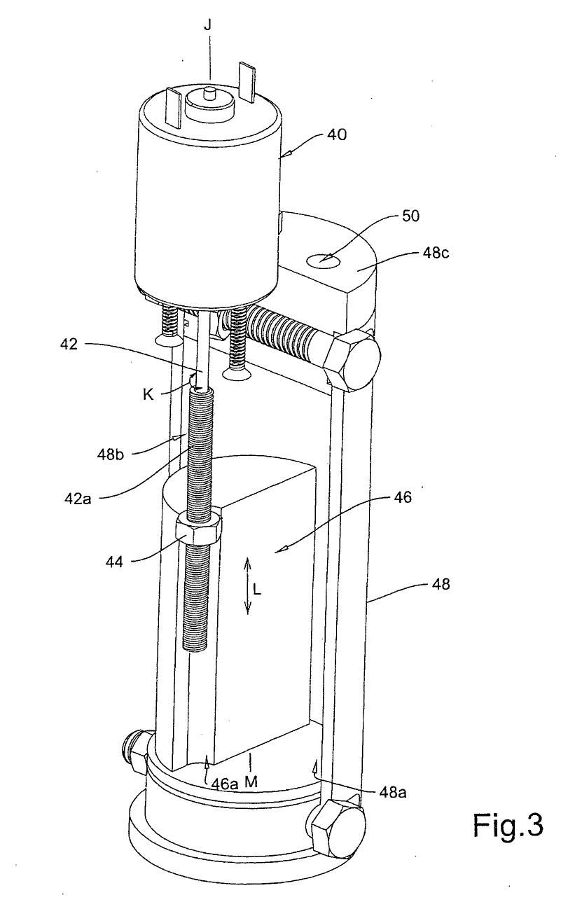

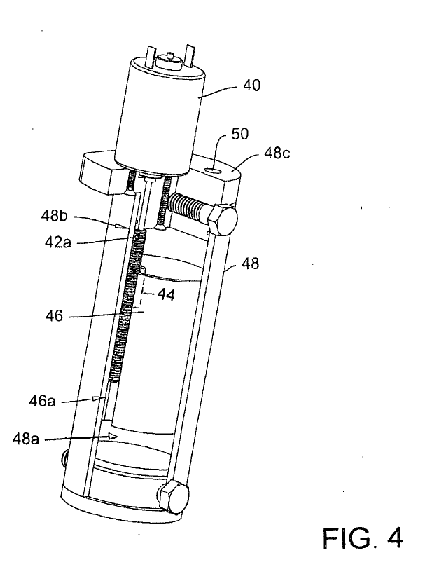

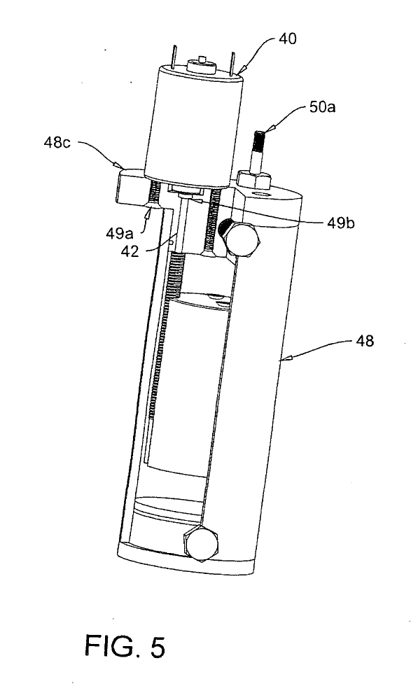

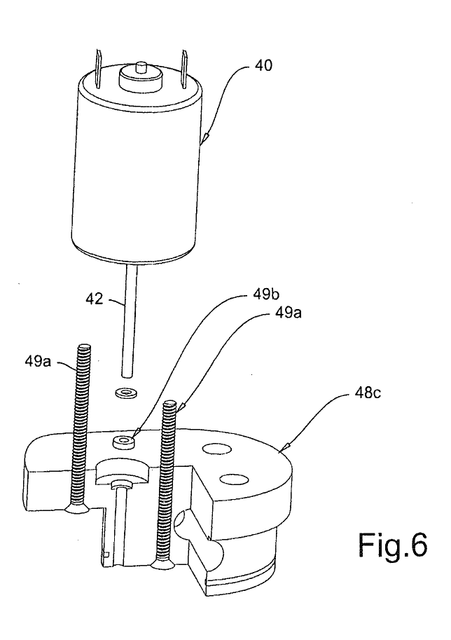

In the alternative embodiment of FIG. 3, the motor 18 from the embodiment of FIG. 1 is replaced with a vertically oriented motor 40. The motor 40 is attached to the top plate 48c by screws 49a. A sealant is used to assure no airflow passes through a smooth transition fit hole in the top plate. At the base of the motor, an o-ring 49b is compressed against the motor shaft to ensure a seal, ensuring that the o-ring does not inhibit the motor shaft from turning. The base of the top plate fits into the end of a 2 inch schedule 40 PVC pipe which forms the cylinder 48. Motor 40 rotates vertically oriented shaft 42 about axis J so as to thereby turn helical threads 42a in direction K. Shaft 42 and threads 42a form a screw that is threadably mounted in internally threaded nut or collar 44 mounted in displacer 46. Threads 42a journalled in nut 44 provide a displacer screw mechanism whereby rotation of shaft 42 by the operation of motor 40 raises or lowers displacer 46 in direction L, the lower end of shaft 42 and threads 42a translating along a correspondingly sized bore 46a extending longitudinally along, and offset from the centroidal axis M, of displacer 46.

Displacer 46 is translated along the length of the hollow cavity 48a which extend along the hollow cylinder 48, cavity 48a including accumulator 48b.

As with the embodiment of FIG. 1, the Stirling cycle operating within cylinder 48 means that the displacer 46 pressurizes accumulator 48b and thereby produces useful work from a power piston (not shown) which is decoupled from displacer 46. The power piston moves within its own power piston cylinder which in is fluid communication with accumulator 48b via piston conduit 50 and one way valve 50a formed in the cylinder head or top plate 48c of cylinder 48. One way valve 50a allows significant pressurization of the power piston cylinder. The power piston cylinder may be mounted directly on to piston conduit 50 and valve 50a or may be mounted remotely therefrom in fluid communication with piston conduit 50 by means of a further length of conduit (not shown).

The displacer screw mechanism including threads 42a and threaded nut or collar 44 is offset from the centroid axis M of displacer 46 so that the offset mass of displacer 46 resists rotating of displacer 46 relative to cylinder 48 as the displacer screw is rotated so as to raise or lower displacer 46.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A low temperature differential Stirling engine comprising:
a sealed elongate hollow container having a correspondingly elongate cavity containing a gaseous working fluid,
a displacer slidably mounted in and translatable along said cavity, wherein said container has a hot end and an opposite cold end and wherein translation of said displacer along said cavity forces said working fluid into said hot or cold ends sequentially according to a Stirling cycle,
wherein said hot end of said container has a power piston conduit in fluid communication with a power piston cylinder containing a power piston slidably mounted therein, said conduit in fluid communication between said working fluid in said cavity in said hot end of said container and said cylinder so that heated expansion of said working fluid in said cavity in said hot end of said container produces a power stroke of said piston in said cylinder,
a power take-off connected to said piston so as to produce useful work from said piston at least during said power stroke,
an actuator mounted substantially within said container and a corresponding processor controlling said actuator, translating said displacer between said hot and cold ends according to and so as to optimize, said Stirling cycle,
and wherein said displacer is mechanically decoupled from said power piston.

2. The engine of claim 1 wherein said actuator includes a motor operating to translate said displacer according to said processor.

3. The engine of claim 2 wherein said power take-off includes a generator driving said motor.

4. The engine of claim 3 wherein said power take-off further includes a transmission producing said useful work including driving said generator.

5. The engine of claim 4 wherein actuator includes a counter-balance counter-balancing said displacer to thereby reduce power requirements of said motor.

6. The engine of claim 5 wherein said actuator further includes an elongate flexible member suspending, on opposite ends thereof, said displacer and said counter-balance, said motor engaging and driving said flexible member so as to translate said counter-balanced displacer.

7. The engine of claim 2 wherein said actuator includes a screw driven by said motor wherein said screw helically engages said displacer to translate said displacer.

8. The engine of claim 7 wherein said screw is off-set from centroidal axis of said displacer so as to inhibit rotation of said displacer relative to said container.

9. The engine of claim 1 wherein said container is a cylinder, and wherein said cavity and said displacer are cylindrical.

10. The engine of claim 1 wherein said processor is adapted to maintain said position of said displacer in said hot end and in said cold end of said container until said working fluid is fully heated when in said hot end and fully cooled when in cold end respectively.

11. The engine of claim 10 wherein said processor is adapted to said maintain said position of said displacer according to active feedback to said processor of the thermodynamic status of said working fluid.

12. The engine of claim 10 wherein said processor is adapted to said maintain said position of said displacer according to a time value.

13. The engine of claim 1 wherein said power take-off provides power to said actuator.
